(19) United States
(12) Patent Application Publication
(10) Pub. No.: US 2015/0109558 A1
(43) Pub. Date: Apr. 23, 2015

(54) LIQUID CRYSTAL DISPLAY DEVICE

(71) Applicant: Japan Display Inc., Tokyo (JP)

(72) Inventors: Shinichiro Oka, Tokyo (JP); Mika Oiwa, Tokyo (JP)

(73) Assignee: Japan Display Inc.

(21) Appl. No.: 14/519,563

(22) Filed: Oct. 21, 2014

(30) Foreign Application Priority Data
Oct. 22, 2013 (JP) 2013-219601

(51) Int. Cl. G02F 1/133; F21V 8/00; G02B 27/30; G02F 1/1335

(52) U.S. Cl. CPC G02F 1/13306; G02F 1/133504; G02F 1/133528; G02F 1/133603; G02B 6/0073; G02B 27/30
USPC 349/65; 349/61

(57) ABSTRACT

A liquid crystal display device includes a backlight provided on a liquid crystal cell in which a liquid crystal layer is interposed between first and second substrates, a first polarizing plate is attached to the outside of the first substrate, and a second polarizing plate is attached to the outside of the second substrate. The liquid crystal cell and the backlight are driven by a field sequential system. A diffusion film is provided on the first polarizing plate which is located on the display surface side of the liquid crystal cell. The backlight is a collimated backlight with a half value width of 20 degrees or less. The viewing angle is increased by the diffusion film while the reduction of the contrast due to the use of the diffusion film is prevented by the collimated backlight, to achieve a liquid crystal display device with sufficient response time and contrast.

### CLAIM OF PRIORITY

The present application claims priority from Japanese Patent Application JP 2013-219601 filed on Oct. 22, 2013, the content of which is hereby incorporated by reference into this application.

### BACKGROUND

The present invention relates to a display device with a backlight, and more particularly, to a liquid crystal display device using a field sequential system.

A display device with a backlight, for example, a liquid crystal display device includes a TFT substrate in which pixel electrodes, thin film transistors (TFT), and the like, are formed in a matrix pattern. Further, a counter substrate is disposed opposite the TFT substrate, in which a color filters and the like are formed at positions corresponding to the pixel electrodes of the TFT substrate. A liquid crystal is interposed between the TFT substrate and the counter substrate. Then, the transmittance of light caused by liquid crystal molecules is controlled at every pixel to form images.

The liquid crystal display device can be made small and thin, and is used in various fields. The liquid crystal does not emit any light of its own, so that a backlight is provided on the back side of a liquid crystal display panel. In order to improve the use efficiency of backlight, there is a technique to increase the amount of light in the direction perpendicular to the surface of the liquid crystal display panel by the use of a prism sheet and the like.

Japanese Unexamined Patent Application Publication No. 2008-250334) describes a light collecting element that can extract the emitted light as polarized light, without being dependent on the azimuth angle, by laminating a circular polarizing reflection plate and a retardation plate. I DW′11 LCT p4-14L describes an example of the diffusion film.

### SUMMARY

A so-called field sequential driving method is a driving method of the liquid crystal display device, which may use color filters but can operate without using color filters, so that the energy efficiency of the backlight is excellent.

FIGS. 7A and 7B are schematic views of the principle of the field sequential system. FIG. 7A shows a pattern displayed in the display area of the liquid crystal cell, showing a display state of a strip-shaped pattern of red, green, blue, and white. FIG. 7B shows the state of the backlight emitting light of red, green, and blue by diving one field into 3 subfields to obtain the display of FIG. 7A. In other words, the display pattern is changed by changing the signal voltage applied to the liquid crystal cell according to the light emission period of each color, to allow the pattern of FIG. 7A to be viewed after the three subfields are displayed. FIGS. 7A and 7B show an example of three subfields of general RGB. However, the present invention is not limited to this example, and can also be applied to a field sequential system for complementary colors to emit light of colors that are complementary to one another.

The most important problem for the field sequential operation is that the response speed of the liquid crystal is slow. In general, the response of the liquid crystal can be expressed by Equation 1 and Equation 2.

$$\begin{matrix}Equation 1 & \\ {τ}_{off} = \frac{{γ}_{1} {d}^{2}}{{π}^{2} K} & ( 1 ) \\ Equation 2 & \\ {τ}_{on} = \frac{{γ}_{1}}{{ɛ}_{0} \vert Δ ɛ \vert {E}^{2} - \frac{{π}^{2}}{{d}^{2}} K} & ( 2 )\end{matrix}$$

In Equation 1, τoff is the response time when the voltage is turned off, and τon is the response time when the voltage is turned on. Further, γ1 is the rotational viscosity coefficient of the liquid crystal material, d is the gap of the liquid crystal layer, K is the elastic constant of the liquid crystal material, and Δε is the dielectric constant anisotropy.

As can be seen from Equations 1 and 2, the response time of the liquid crystal is proportional to the square of the gap, and is proportional to the elastic constant. The elastic constant depends on the liquid crystal display mode. Although some liquid crystal display modes have a short response time, there are also modes with insufficient viewing angle. In addition, the contrast may be reduced with a configuration in which the viewing angle is increased.

An object of the present invention is to achieve a liquid crystal display device with sufficient response time for the field sequential operation, and with sufficient viewing angle or screen contrast.

The present invention is made to solve the above problems with specific means as follows:

(1) There is provided a liquid crystal display device including a backlight provided on the back side of a liquid crystal cell in which a liquid crystal layer is interposed between a first substrate and a second substrate, a first polarizing plate is attached to the outside of the first substrate, and a second polarizing plate is attached to the outside of the second substrate. The liquid crystal cell and the backlight are driven by a field sequential system. A diffusion sheet is attached on the first polarizing plate which is located on the display surface side of the liquid crystal cell. The backlight is a collimated backlight with a half value width of 20 degrees or less.

(2) There is provided a liquid crystal display device including a backlight provided on the back side of a liquid crystal cell in which a liquid crystal layer is interposed between a first substrate and a second substrate, a first polarizing plate is attached to the outside of the first substrate, and a second polarizing plate is attached to the outside of the second substrate. The liquid crystal cell and the backlight are driven by a field sequential system. A diffusion film is provided between the first polarizing plate and the first substrate, which are located on the display surface side of the liquid crystal cell. The backlight is a collimated backlight with a half value width of 20 degrees or less.

(3) There is provided a liquid crystal display device including a backlight provided on the back side of a liquid crystal cell in which a liquid crystal layer is interposed between a first substrate and a second substrate, a first polarizing plate is attached to the outside of the first substrate, and a second polarizing plate is attached to the outside of the second substrate. The liquid crystal cell and the backlight are driven by a field sequential system. A diffusion film is provided on the side of the liquid crystal layer of the first substrate, which is located on the display surface side of the liquid crystal cell. The backlight is a collimated backlight with a half value width of 20 degrees or less.

According to the present invention, it is possible to achieve a field sequential system liquid crystal display device with sufficient response speed for the field sequential operation, and with the useful viewing angle and contrast properties.

### BRIEF DESCRIPTION OF THE DRAWINGS

FIG. 1 is a schematic cross-sectional view of a liquid crystal display device according to the present invention;

FIG. 2 is a cross-sectional view of a liquid crystal cell;

FIG. 3 is a detailed cross-sectional view of the liquid crystal cell;

FIG. 4 is a plan view showing a pixel structure in a TFT substrate;

FIG. 5 is a cross-sectional view showing an example of a backlight according to the present invention;

FIGS. 6A and 6B are views for comparing between the viewing angles with and without a diffusion film;

FIGS. 7A and 7B are views of the field sequential operation;

FIGS. 8A and 8B are views of the influence of the back scattering of the diffusion film;

FIG. 9 is a schematic cross-sectional view showing an example of the backlight according to the present invention;

FIG. 10 is a table showing the influence of the diffusion film and collimated backlight on the contrast;

FIG. 11 is the definition of the half value width of the backlight;

FIG. 12 is a graph showing the relationship between the half value width of the backlight and the contrast, according to the present invention;

FIG. 13 is a schematic view showing the field sequential operation according to the present invention;

FIG. 14 is an example of the backlight used in the present invention;

FIG. 15 is another example of the backlight used in the present invention;

FIGS. 16A and 16B are examples of an LED package used in the present invention;

FIG. 17 is still another example of the backlight used in the present invention;

FIG. 18 is a cross-sectional view showing a second embodiment of the present invention; and

FIG. 19 is a cross-sectional view showing a third embodiment of the present invention.

### DETAILED DESCRIPTION

Hereinafter, the details of the present invention will be described with reference to the preferred embodiments.

### First Embodiment

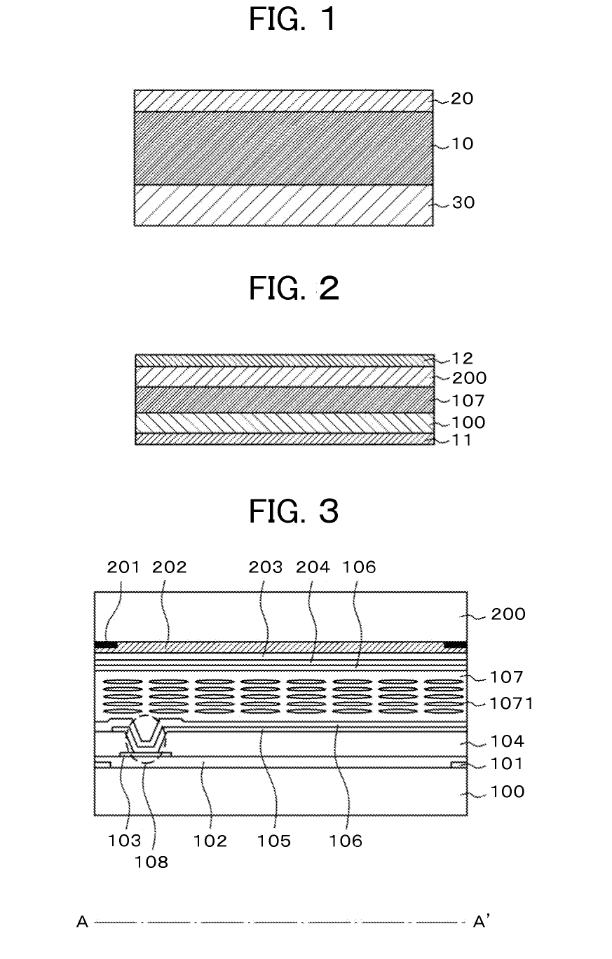

FIG. 1 is a cross-sectional view of a liquid crystal display device according to the present invention. The liquid crystal display device of FIG. 1 is driven by a field sequential system. In FIG. 1, a backlight 30 is provide on the back side of a liquid crystal cell 10, and a diffusion film 20 is present on the display surface side of the liquid crystal cell 10. The diffusion film 20 has a function of providing a wide view by diffusing the light emitted from the liquid crystal cell 10. The diffusion film 20 can be formed, for example, by scattering particles with different refractive indices on a certain medium. The property of the diffusion film 20 is such that the one with less back scattering can prevent the reduction of the contrast.

The liquid crystal display device of FIG. 1 operates by a field sequential system, which can use the backlight 30 whose color changes according to time. The most popular light source is LED, but other light sources such as OLED and inorganic EL can also be used. However, the backlight 30 used in the present invention should be a collimated backlight in order to prevent the reduction of the contrast.

FIG. 2 is a cross-sectional view of the liquid crystal cell shown in FIG. 1. In FIG. 2, a liquid crystal layer 107 is interposed between a TFT substrate 100 and a counter substrate 200. A lower polarizing plate 11 is attached on the lower side of the TFT substrate 100. Then, an upper polarizing plate 12 is attached on the upper side of the counter substrate 200. In addition to the polarization plates, a retardation plate may also be used in order to change the direction of the polarized light. Glass is generally used for the TFT substrate 100 and the counter substrate 200. However, a plastic substrate or a composite plate of a glass substrate and a plastic substrate may also be used.

FIG. 3 is a detailed cross-sectional view of the liquid crystal cell, excluding the polarizing plates. FIG. 3 shows a so-called twisted nematic (TN) mode liquid crystal cell. In FIG. 3, a color filter 202 is formed on the counter substrate 200. The liquid crystal display device is driven by the field sequential system and does not necessarily require the color filter 202. It is possible that the color filter 202 is not present in the field sequential liquid crystal display device.

In FIG. 3, a scanning line 101 is formed on the TFT substrate 100, and a gate insulating film 102 is formed so as to cover the scanning line 101. A source electrode 103 extending from a TFT, not shown, is formed on the gate insulating film 102. Then, a passivation film 104 is formed so as to cover the TFT (not shown), the source electrode 103, the gate insulating film 102, and the like. The passivation film 104 may be formed by an inorganic film or by an organic film. A pixel electrode 105 is formed on the passivation film 104. Then, an alignment film 106 is formed so as to cover the pixel electrode 105. The pixel electrode 105 is coupled to the source electrode 103 through a through hole 108.

A black matrix 201 is formed in the counter substrate 200, and a color filter 202 is formed corresponding to each pixel. It is also possible that the color filter 202 is not present in the field sequential system. An overcoat film 203 is formed so as to cover the color filter 202, and a counter electrode 204 is formed on the overcoat film 203. Then, the alignment film 106 is formed so as to cover the counter electrode 204.

In FIG. 3, the liquid crystal layer 107 is interposed between the TFT substrate 100 and the counter substrate 200. A liquid crystal molecule 1071 has a positive dielectric constant. When a voltage is applied between the pixel electrode 105 and the counter electrode 204, the liquid crystal molecule 1071 rises up in the vertical direction to change the transmittance of the liquid crystal layer 107. Note that FIG. 3 shows the TN mode liquid crystal cell, but the present invention is not limited to this example and can also be applied to a so-called Vertical Alignment (VA) mode liquid crystal cell or a so-called In Plane Switching (IPS) mode liquid crystal cell.

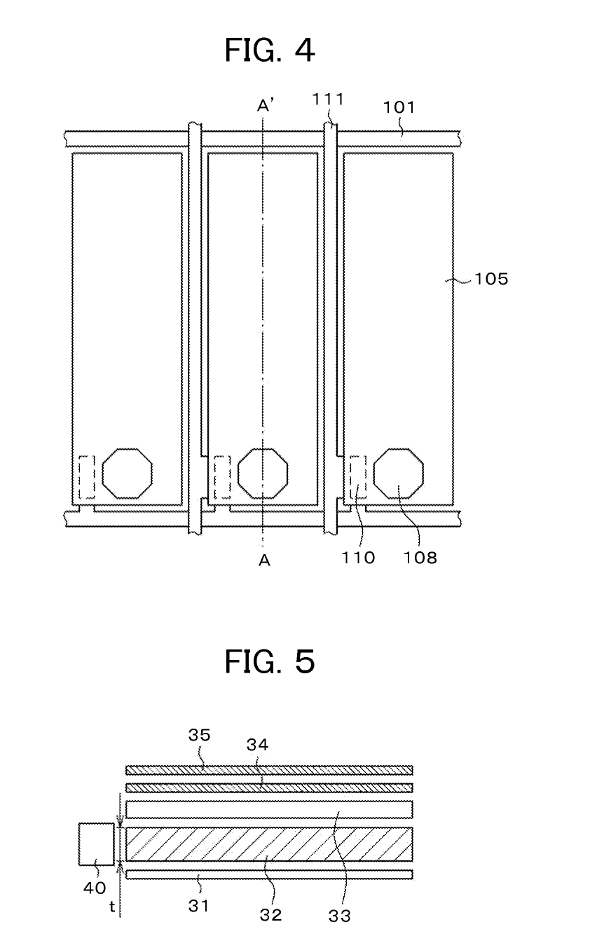

FIG. 4 is a plan view of a pixel structure of the liquid crystal cell in the TFT substrate 100. Note that FIG. 3 is a cross-sectional view taken along line A-A′ in FIG. 4. In FIG. 4, the pixel electrode 105 is formed in a flat shape in the area surrounded by the scanning lines 101 and video signal lines 111. The dashed line in the lower left of the pixel indicates the position of a TFT 110. The pixel electrode 105 is coupled to the source electrode (not shown) extending from the TFT 110 through the through hole 108.

FIG. 5 is an example of the backlight 30 shown in FIG. 1. The present invention is used in the field sequential system, so that the color of the light emitted from the backlight of FIG. 5 changes according to time. In FIG. 5, an LED package 40, which is a light source, is provided on the side surface of a light guide plate 32. The thickness of the light guide plate 32 is represented by t. The light guide plate 32 converts the light entering from the side surface into surface emission. The light guide plate 32 can be formed of a resin such as, for example, acrylic or polycarbonate.

The LED package 40 includes multiple LED chips that emit light of different colors. The packaged LED chips should be arranged sufficiently close to each other to achieve the field sequential operation.

A diffusion sheet 33 is provided on the light guide plate. Then, two prism sheets, namely, a second prism sheet 34 and a first prism sheet 35 are provide in this order on the diffusion sheet 33. The light from the backlight 30 used in the present invention should be sufficiently collimated. Thus, the present invention uses a so-called reverse prism sheet, which is a prism sheet in which unevenness is formed on the underside, in order to increase the collimating efficiency. The prism sheet can be formed of a resin such as, for example, acrylic or polycarbonate.

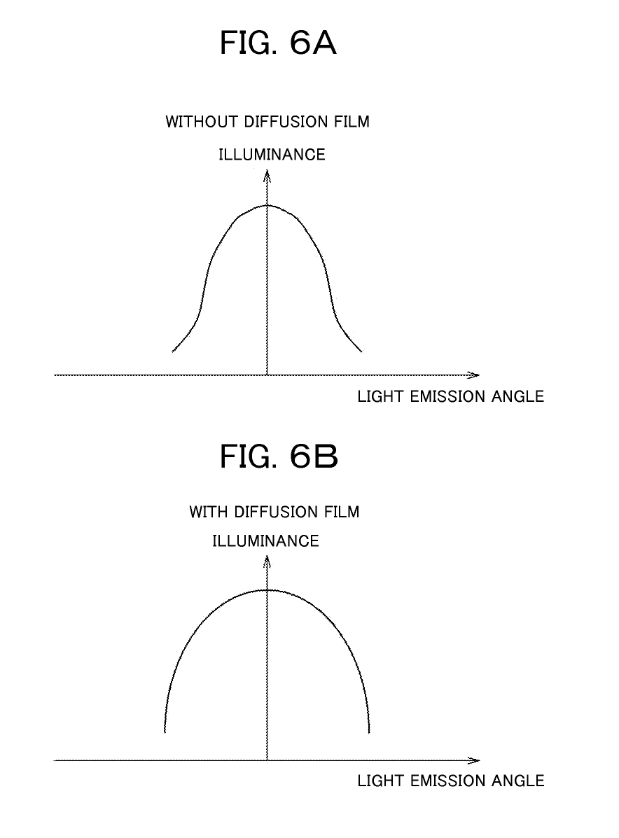

FIGS. 6A and 6B are graphs showing the difference between the viewing angle property when the diffusion sheet is provided on the display surface side of the liquid crystal cell as shown in the present invention and the viewing angle property when the diffusion sheet is not provided. FIG. 6A is the viewing angle property when the diffusion film is not used, and FIG. 6B is the viewing angle property when the diffusion film according to the configuration of the present invention is used. As can be seen by comparing FIG. 6A and FIG. 6B, according to the configuration of the present invention, the viewing angle is significantly increased. Thus, even if the viewing angle of the liquid crystal cell is reduced as a result of increasing the response speed of the liquid crystal cell so as to enable the field sequential operation, it is possible to increase the viewing angle by providing the diffusion film on the display surface side of the liquid crystal cell as described in the present invention.

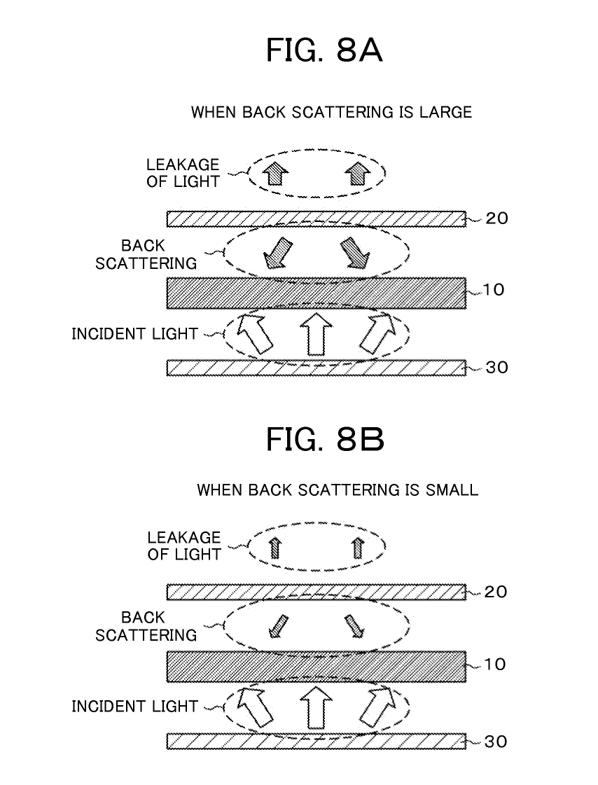

However, the use of the diffusion film 20 on the display surface side of the liquid crystal cell 10 results in the reduction of the contrast. This is due to the back scattering occurring in the diffusion film 20. FIG. 8A is an example in which the back scattering of the diffusion film 20 is large, showing that the amount of leakage of light passing through the diffusion film 20 is large. In other words, it is shown that the contrast is reduced. On the other hand, FIG. 8B is an example in which the back scattering of the diffusion film 20 is small, showing that the amount of leakage of light passing through the diffusion film 20 is small. In other words, it is shown that the reduction of the contrast is small.

In other words, when back scattering is present, the back scattered light returns to the liquid crystal layer. As a result, internal reflection occurs within the liquid crystal cell 10 and the polarization state is broken, and then light leakage occurs in black display. Thus, in the present invention, it is desirable to use the diffusion film 20 in which the back scattering is small. The best way is to use a diffusion film with no back scattering.

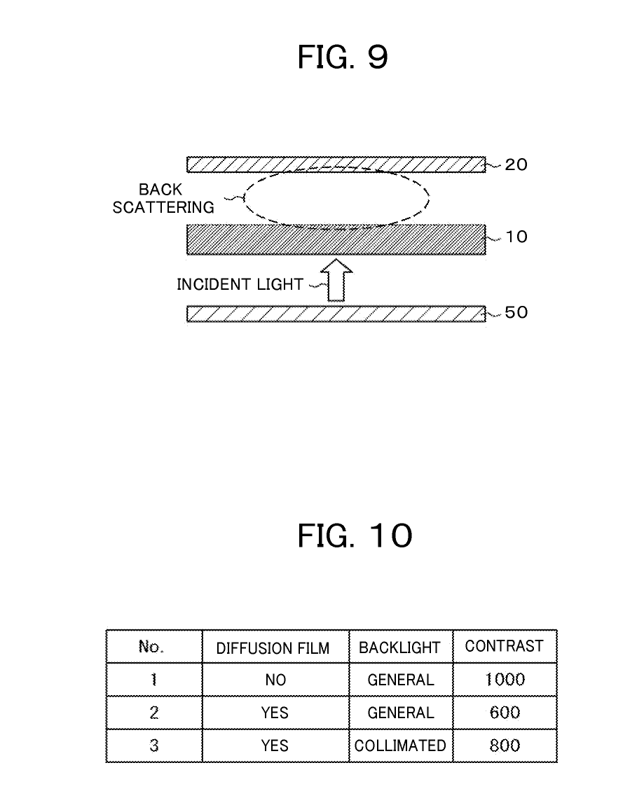

On the other hand, if it is difficult to avoid back scattering of the diffusion film 20, the light leakage is reduced by increasing the light collection ratio of the backlight 30, in order to prevent the reduction of the contrast. In other words, as shown in FIG. 9, if the light is incident only in the normal direction of the liquid crystal cell 10, the angle of the light reflecting on the side of the liquid crystal cell 10 from the diffusion film 20 with respect to the normal line of the liquid crystal cell 10 is reduced, even if back scattering occurs due to the presence of the diffusion film 20. The greater the angle of the reflected light with respect to the normal line of the liquid crystal cell 10, the greater the disappearance of polarization due to internal scattering. Thus, the contrast is reduced. On the other hand, when the angle of the reflected light with respect to the normal line of the liquid crystal cell 10 is small, the disappearance of polarization is prevented. As a result, the amount of leakage of light can be reduced, and thus the reduction of the contrast can be prevented.

FIG. 10 is a table comparing the contrast in the general liquid display device, and the contrast when the diffusion film 20 is provided on the display surface side of the liquid crystal cell 10 as described in the present invention. In FIG. 10, the diffusion film 20 is not present in the general liquid crystal display device shown in No. 1. In this case, although the viewing angle is small, the contrast is kept high because the diffusion film 20 is not used. This contrast is set to 1000 as reference.

On the other hand, No. 2 in FIG. 10 shows the contrast when the general backlight is used and the diffusion film 20 is used. In other words, although the viewing angle is increased because of the use of the diffusion film 20, the contrast is reduced to 600 compared with the contrast in the existing liquid crystal display device. No. 3 in FIG. 10 shows the contrast when the collimated backlight with a strong light collection capability is used as the backlight as described in the present invention. In No. 3, the contrast is increased to 800 because of the use of the collimated backlight. In addition, the viewing angle is increased by the use of the diffusion film 20 compared with the viewing angle in the existing liquid crystal display device.

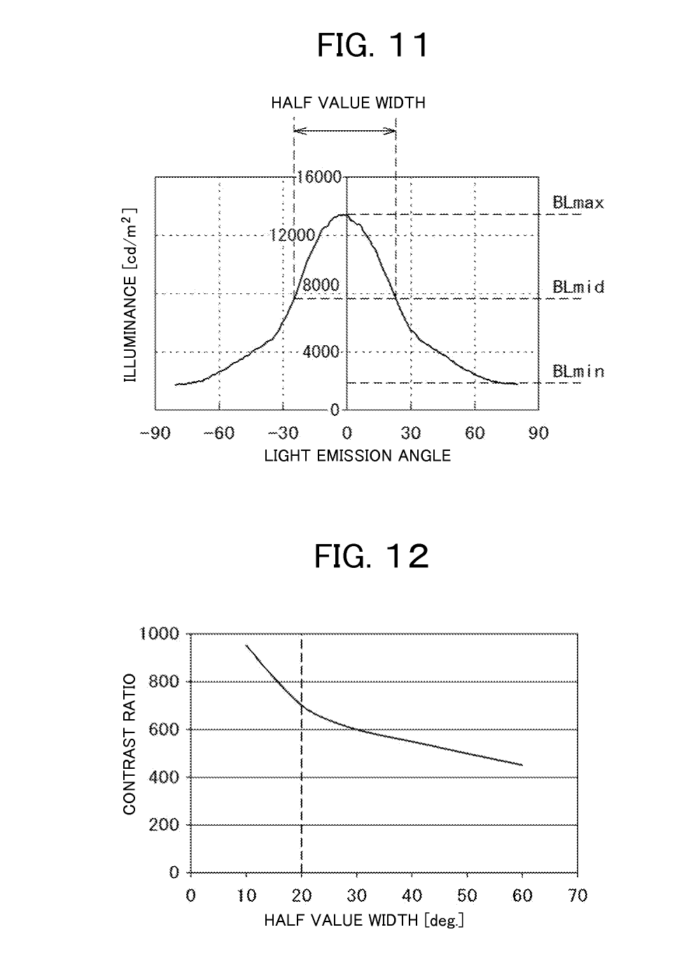

As described above, in the present invention, the diffusion film 20 is provided on the display surface side of the liquid crystal cell 10, and at the same time, the collimated backlight 30 is used as shown in No. 3, in order to increase the viewing angle and keep the contrast within a practical range. FIG. 11 is a view of the definition of half value width of the backlight, which is an indication of the light collection ratio of the collimated backlight 30. In FIG. 11, the BLmid is defined by BLmid=(BLmax−BLmin)/2, which is approximately half the difference between the maximum illuminance and the maximum illuminance value BLmax and the minimum illuminance value BLmin of the backlight.

FIG. 12 is a graph plotting the half value width of the backlight on the horizontal axis and the contrast ratio on the vertical axis, in the configuration of the present invention. The contrast ratio is rapidly increased when the half value width of the backlight is 20 degrees or less. As a result, in the configuration shown in FIG. 1, it is possible to achieve a liquid crystal display device capable of the field sequential operation with the viewing angle property kept large and the contrast kept constant, by using the collimated backlight in which the half value width of the backlight is set to 20 degrees or less. Note that the requirements of the half value width of 20 degrees or less are not necessarily satisfied by all azimuth angles. It is possible that the half value width is 20 degrees or less in only one azimuth angle direction.

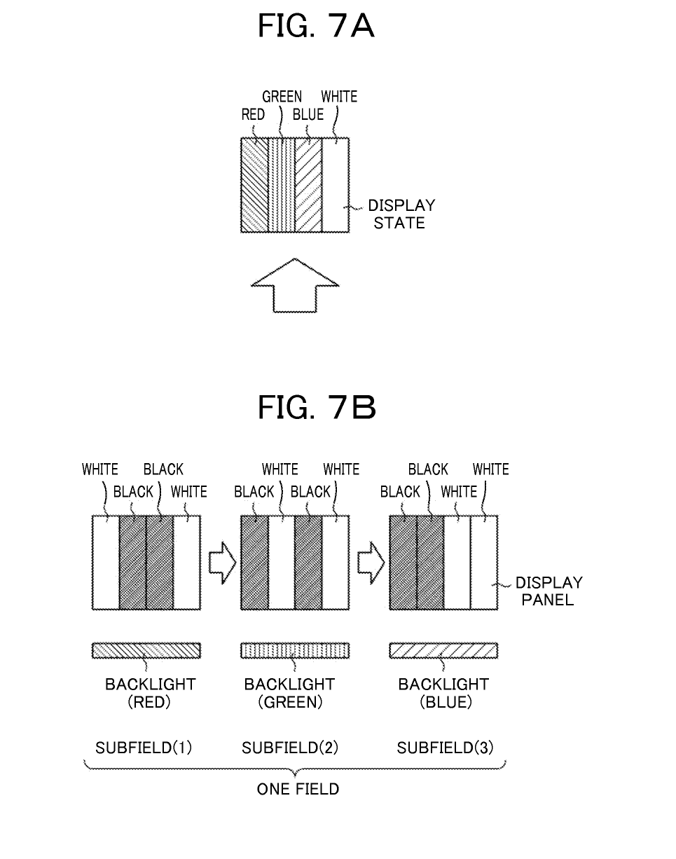

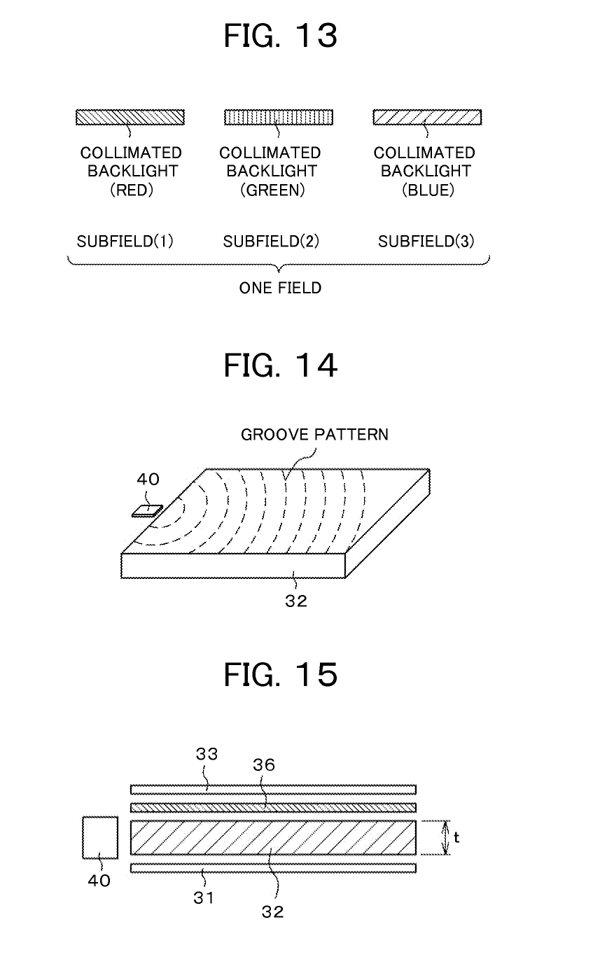

FIG. 13 is a schematic view of the backlight used in the present invention. The backlight shown in FIG. 13 has the same configuration as that of the backlight shown in FIG. 7, but is different in that the half value width of the backlight is 20 degrees or less. The property of changing color for each subfield in one field is the same as that in FIG. 7.

FIG. 14 shows a specific example of the configuration of the backlight used in the present invention. FIG. 14 shows a backlight called vector type. In FIG. 14, a single LED package 40 is provided on the side surface of the light guide plate 32. Multiple LED chips that emit light of different colors are placed in the single LED package 40. The distance between the LED chips is set to be sufficiently small so that the light from each LED chip is emitted from the main surface of the light guide plate with a substantially uniform illuminance distribution.

In FIG. 14, grooves are formed on the light emission surface of the light guide plate 32, substantially concentrically around the LED package 40. Note that it is possible to form ridges instead of grooves. A reflection sheet is provided on the lower side of the light guide plate, and a diffusion sheet and a prism sheet are provided on the upper side of the light guide plate according to need. However, these components are omitted in FIG. 14.

FIG. 15 is another example of the backlight used in the present invention. In FIG. 15, the LED package 40 is provided on a side surface of the light guide plate 32. The thickness of the light guide plate 32 is t. The LED package 40 is formed in such a way that multiple LED chips that emit light of different colors are placed in one package. At this time, the distance between the LED chips is reduced to enable the field sequential driving. In FIG. 15, a reflection sheet 31 is provided on the back surface of the light guide plate 32. Then, a reverse prism sheet 36 and a diffusion sheet 33 are laminated on the light emission surface side of the light guide plate 32. Here, the prism sheet 36 is the so-called reverse prism sheet 36 with better light collecting effect. Two prism sheets 36 may be provided if required.

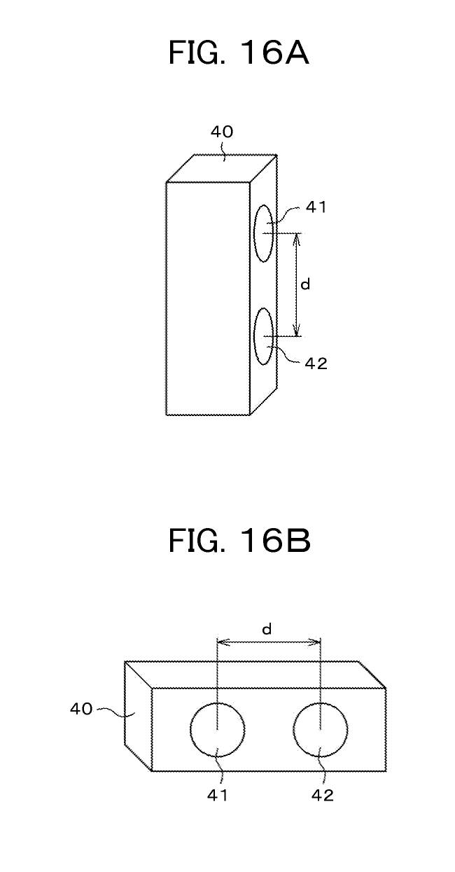

FIGS. 16A and 16B are examples of the LED package 40 used in FIG. 15. FIG. 16A is an example in which two LED chips with different emission colors, a first LED chip 41 and a second LED chip 42, are arranged in the vertical direction in the package 40. The distance d between the LED chips in FIG. 16A is smaller than the thickness t of the light guide plate 32. Here, if there is a difference between the thickness of the side surface on which the LED package 40 is provided and the thickness of the other side surface in the light guide plate 32, the thickness t of the light guide plate 32 is that of the side surface on which the LED package 40 is provided.

FIG. 16B is an example in which two LED chips, the first LED chip 41 and the second LED chip 42, are arranged in the horizontal direction in the LED package 40. In FIG. 16B, when t is the thickness of the light guide plate 32, the distance d between the two LED chips is 5t or less, preferably 2t or less, and more preferably t or less.

FIGS. 16A and 16B are examples in which two LED chips are placed in the LED package 40. However, three or more LED chips may be placed in the LED package 40. In this case also, the distance between the both ends of the LED chips, which are vertically arranged as shown in FIG. 16A, is equal to or less than the thickness t of the light guide plate, and the distance between the LED chips, which are horizontally arranged as shown in FIG. 16B, is 5t or less, preferably 2t or less, and more preferably t or less. Note that if the distance of the LED package 40 along the side of the light guide plate 32 is defined as D, the distance d between the LED chips within the LED package 40 is preferably half of D or less.

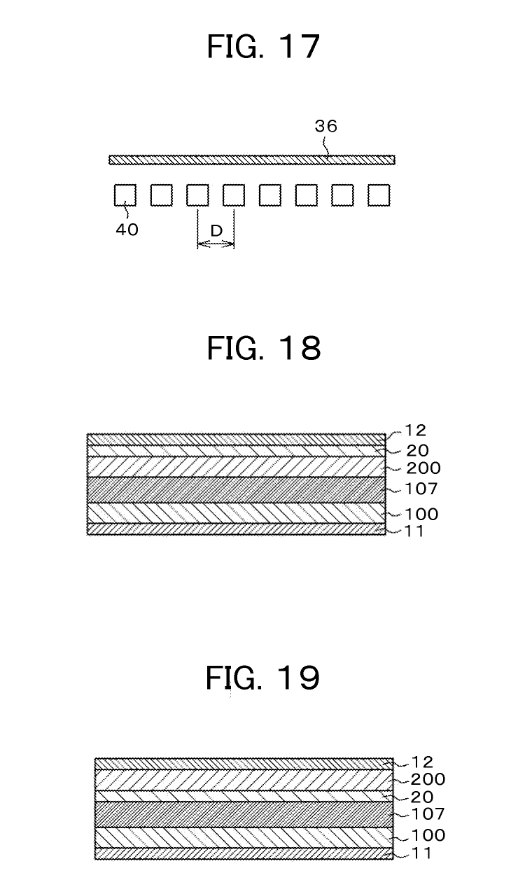

FIG. 17 is the case where the backlight 30 used in the present invention shown in FIG. 1 is a direct-type backlight. In FIG. 17, the LED package 40 is provided below the prism sheet 36. Multiple LED chips that emit light of different colors are placed in the LED package 40. In this way, it is designed to reduce the distance between the LED chips so as to enable the field sequential driving.

In FIG. 17, the distance D between the LED packages is selected so as not to cause uneven brightness. The arrangement of the LED chips in the LED package 40 in FIG. 17 is the same as the arrangement of the LED ships in the LED package 40 shown in FIG. 16B. In FIG. 17, if the distance between the LED chips that emit light of different colors in the LED package 40 is d, d is half of D or less. Also when the number of LED chips in the LED package 40 is three or more, the distance d between the both ends of the LED chips is set to half or less of the distance D between the LED packages.

### Second Embodiment

FIG. 18 is a cross-sectional view of a second embodiment according to the present invention. Also in the second embodiment, the collimated backlight described in the first embodiment is used on the back surface of the liquid crystal cell. FIG. 18 is different from FIG. 1 in that the diffusion film 20 is integrated into the liquid crystal cell. In FIG. 18, the diffusion film 20 is provided between the upper polarizing plate 12 and the counter substrate 200. At this time, it is desirable that the diffusion film 20 is a film in which the polarization does not disappear.

The diffusion film 20, as well as the inner surface of the counter substrate 200 on which an image is formed are placed as close as possible in order to reduce image blue. Thus, the present embodiment can reduce image blur more effectively than the configuration of the first embodiment. FIG. 18 is an example in which the diffusion film 20 is provided separately from the upper polarization plate 12. In this case, it is possible to function as a diffusion film by giving the diffusion effect to the adhesive attaching the upper polarizing plate 12 to the counter substrate 200.

### Third Embodiment

FIG. 19 is a cross-sectional view of a third embodiment according to the present invention. Also in the third embodiment, the collimated backlight described in the first embodiment is used on the back surface of the liquid crystal cell. In FIG. 19, the diffusion film 20 is formed on the inner surface of the counter substrate 200 in the liquid crystal cell. The diffusion film 20 may be formed on the inner surface of the counter substrate 200 as a separate component. However, it is also possible to allow the layer in the counter substrate to have the same effect of the diffusion film.

The overcoat layer is an example of the layer capable of having the same effect of the diffusion film in the counter substrate. Further, when color filters are present, it is possible to allow the color filters to have the same effect of the diffusion film. In this case, the image blur can be further reduced than in the second embodiment.

What is claimed is:

1. A liquid crystal display device comprising a backlight provided on the back side of a liquid crystal cell,
wherein the liquid crystal cell has a structure in which a liquid crystal layer is interposed between a first substrate and a second substrate, a first polarizing plate is attached to the outside of the first substrate, and a second polarizing plate is attached to the outside of the second substrate,
wherein the liquid crystal cell and the backlight are driven by a field sequential system,
wherein a diffusion film is attached to the first polarizing plate which is located on the display surface side of the liquid crystal cell, and
wherein the backlight is a collimated backlight with a half value width of 20 degrees or less.

2. The liquid crystal display device according to claim 1,
wherein an LED package is provided on a side surface of a light guide plate of the backlight, and
wherein a plurality of LED chips that emit light of different colors are placed in the LED package.

3. The liquid crystal display device according to claim 2,
wherein when the thickness of the side surface of the light guide plate is t, and when the distance between the LED chips provided on the outside of the plurality of LED chips in the LED package is d, d is equal to 5t or less.

4. The liquid crystal display device according to claim 3,
wherein when the thickness of the side surface of the light guide plate is t, and when the distance between the LED chips provided on the outside of the plurality of LED chips in the LED package is d, d is equal to 2t or less.

5. The liquid crystal display device according to claim 1,
wherein the plurality of LED packages are arranged on the side surface of the light guide plate.

6. The liquid crystal display device according to claim 1,
wherein an LED package is provided below a prism sheet in the backlight,
wherein a plurality of LED chips that emit light of different colors are placed in the LED package, and
wherein when the distance of the LED package is D, and when the distance between the LED chips in the LED package is d, d is half of D or less.

7. A liquid crystal display device comprising a backlight provided on the back side of a liquid crystal cell,
wherein the liquid crystal cell has a structure in which a liquid crystal layer is interposed between a first substrate and a second substrate, a first polarizing plate is attached to the outside of the first substrate, and a second polarizing plate is attached to the outside of the second substrate,
wherein the liquid crystal cell and the backlight are driven by a field sequential system,
wherein a diffusion film is provided between the first polarizing plate and the first substrate, which are located on the display surface side of the liquid crystal cell, and
wherein the backlight is a collimated backlight with a half value width of 20 degrees or less.

8. A liquid crystal display device comprising a backlight provided on the back side of a liquid crystal cell,
wherein the liquid crystal cell has a structure in which a liquid crystal layer is interposed between a first substrate and a second substrate, a first polarizing plate is attached to the outside of the first substrate, and a second polarizing plate is attached to the outside of the second substrate,
wherein the liquid crystal cell and the backlight are driven by a field sequential system,
wherein a diffusion film is provided on the side of the liquid crystal layer of the first substrate, which is located on the display surface side of the liquid crystal cell, and
wherein the backlight is a collimated backlight with a half value width of 20 degrees or less.
